(19) United States
(12) Patent Application Publication
(10) Pub. No.: US 2026/0281141 A1
(43) Pub. Date: Sep. 17, 2026

(54) MANIFEST-BASED APP RISK EVALUATION ENGINE IN A SECURITY MANAGEMENT SYSTEM

(71) Applicant: Microsoft Technology Licensing, LLC, Redmond, WA (US)

(72) Inventors: Uri Yehuda Oren, Hasharon (IL); Dor Edry, Modi’in Makabim Reut (IL)

(21) Appl. No.: 19/081,979

(22) Filed: Mar. 17, 2025

(51) Int. Cl. H04L 9/40; G06F 21/57

(52) U.S. Cl. CPC H04L 63/1433; G06F 21/577; H04L 63/20; G06F 2221/033

(57) ABSTRACT

Methods, systems, and computer storage media for providing manifest-based app risk evaluation using a manifest-based app risk evaluation engine of a security management system are described. Manifest-based app risk evaluation refers to the process of analyzing an application's manifest file to assess security risks by examining manifest-based security factors of the application and assigning a risk score to guide deployment decisions. The manifest-based app risk evaluation engine enables manifest ingestion and validation, security analysis and risk scoring, and classification with reporting. In operation, a manifest associated with an application is accessed. The manifest is analyzed based on a plurality of manifest-based app risk evaluation rules. A risk score is generated for the manifest based on a plurality of manifest-based security factors that correspond to the plurality of manifest-based app risk evaluation rules. A risk report associated with the application is generated. The risk report is then communicated to a client.

### BACKGROUND

Users rely on communication platforms to collaborate through chat, video calls, and file sharing. Communication platforms have evolved beyond simple messaging tools to become comprehensive hubs that integrate various features such as video conferencing, file sharing, task management, and third-party app integrations. Communication platforms enable seamless communication across teams and organizations and allow for customization through app extensions, automation, and integrations with external software. In addition to communication platforms, several other types of digital platforms also support application “app” stores and third-party integrations. For example, project management platforms can integrate with time-tracking apps or document-sharing tools. CRM systems might offer integrations with email marketing or customer support apps. Cloud storage platforms can offer integrations with document editing or collaboration tools.

### SUMMARY

Various aspects of the technology described herein are generally directed to systems, methods, and computer storage media for, among other things, providing manifest-based app risk evaluation using a manifest-based app risk evaluation engine of a security management system. Security management generally refers to planning, implementing, controlling, and monitoring security measures to protect assets, resources, and information from various threats and risks in computing environment. Manifest-based app risk evaluation refers to the process of analyzing an application's manifest file to assess security risks by examining manifest-based security factors (e.g., permissions, integrations, authentication methods, and external dependencies) of the application and assigning a risk score to guide deployment decisions. The manifest-based app risk evaluation engine enables manifest ingestion and validation, security analysis and risk scoring, and classification with reporting. These processes work together to provide a structured, automated evaluation of apps in a digital platform, ensuring that organizations can assess security risks efficiently and consistently before approving app installations.

Conventionally, security management systems are not configured with a comprehensive computing logic and infrastructure to efficiently and effectively automate the security evaluation of app in digital platforms. The core problem lies in the difficulty of manually reviewing and assessing the security posture of every app that users request for installation. Apps may request extensive permissions, interact with external domains, or access sensitive data, creating potential vulnerabilities that could expose organizations to compliance risks, data breaches, or unauthorized access. Traditional security reviews are labor-intensive and do not scale effectively as the number of applications in an enterprise environment grows. Without an efficient, repeatable process for assessing risk, organizations face a bottleneck where security teams struggle to keep up with the increasing volume of app approval requests, leading to delays, inconsistent evaluations, or approval of high-risk apps.

A technical solution—to the limitations of conventional security management systems—can include providing a manifest-based app risk evaluation engine that automates security assessments for apps by analyzing their manifest files. First, the manifest-based app risk evaluation engine validates and parses manifests (e.g., JSON manifests) rejecting malformed files to prevent potential security risks. Next, manifest-based app risk evaluation engine evaluates manifest-based security factors such as permissions, integrations, authentication, and external dependencies, assigning a weighted risk score (e.g., 0-100) based on severity. Finally, it classifies apps using a classification framework (e.g., Low, Medium, or High Risk), generating structured reports and visualizations to help security teams make informed approval decisions and users are also informed about the security risk of particular apps. The manifest-based app risk evaluation engine enhances security by proactively identifying high-risk applications before deployment, preventing potential data breaches and unauthorized access.

In operation, in a first embodiment, a manifest associated with an application is accessed. The manifest is analyzed based on a plurality of manifest-based app risk evaluation rules. A manifest-based app risk evaluation rule is a security policy that supports evaluating a risk level of applications based on corresponding manifests. Based on analyzing the manifest, a risk score is generated for the manifest based on a plurality of manifest-based security factors that correspond to the plurality of manifest-based app risk evaluation rules. Based on generating the risk score, a risk report associated with the application is generated. The risk report is communicated to a client.

In a second embodiment, a plurality of manifests associated with corresponding applications are accessed. The plurality of manifests is analyzed based on a plurality of manifest-based app risk evaluation rules. A manifest-based app risk evaluation rule is a security policy that supports evaluating a risk level of applications based on corresponding manifests. Based on analyzing the manifest, risk scores are generated. The risk scores correspond to the plurality of manifests. Generating the risk scores is based on a plurality of manifest-based security factors that correspond to the plurality of manifest-based app risk evaluation rules. Based on generating the risk scores, a visualization representing the risk scores associated with the plurality of manifests and the corresponding applications is generated. The visualization supports tracking security risk scores across the plurality of applications.

In a third embodiment, a risk report request for an application is communicated from a client. Based on communicating the risk report request, a risk report is received at the client. The risk report is generated based on analyzing a manifest of the application. Analyzing the manifest is based on a plurality of manifest-based app risk evaluation rules. A manifest-based evaluation rule is a security policy that supports evaluating a risk level of applications based on corresponding manifests. The risk report is caused to be displayed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is a block diagram of an exemplary manifest-based app risk evaluation engine architecture including a manifest-based app risk evaluation engine, in accordance with aspects of the technology described herein;

FIG. 1B is a flow diagram associated with providing manifest-based app risk evaluation using manifest-based app risk evaluation engine, in accordance with aspects of the technology described herein;

FIG. 2A is a block diagram associated with an exemplary security management system including a manifest-based app risk evaluation engine, in accordance with aspects of the technology described herein;

FIG. 2B is a flow diagram associated with providing manifest-based app risk evaluation using manifest-based app risk evaluation engine, in accordance with aspects of the technology described herein;

FIG. 3 provides a first exemplary method of providing manifest-based app risk evaluation using a manifest-based app risk evaluation engine, in accordance with aspects of the technology described herein;

FIG. 4 provides a second exemplary method of providing manifest-based app risk evaluation using a manifest-based app risk evaluation engine, in accordance with aspects of the technology described herein;

FIG. 5 provides a third exemplary method of providing manifest-based app risk evaluation using a manifest-based app risk evaluation engine, in accordance with aspects of the technology described herein;

FIG. 6 provides a block diagram of an exemplary security management system suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

A security management system supports management of security aspects of resources and workloads in computing environments. The security management system can help enable protection against threats, help reduce risk across different types of computing environments and help strengthen a security posture of computing environments—i.e., security status and remediation action recommendations for computing resources including networks and devices. For example, the security management system can provide real-time security alerts, centralize insights for different resources, and provide for preventative protection, post-breach detection, and automated investigation, and response.

Security management systems in digital platforms are designed to safeguard data, control access, and ensure the integrity of systems and applications. Security management systems typically provide tools and features for managing user authentication, authorization, and encryption, helping organizations prevent unauthorized access and protect sensitive information. They offer granular control over permissions, allowing administrators to define who can access what resources within a digital platform. These security management systems often include real-time monitoring to detect and respond to potential security threats, such as malicious activities, data breaches, or unusual access patterns. They can enforce security policies, such as password complexity requirements, multi-factor authentication, and role-based access controls, to ensure that users adhere to security best practices.

Modern digital platforms have evolved to support a wide range of functions beyond their core capabilities, offering users the ability to enhance and customize their experience through app stores and third-party integrations. These digital platforms act as comprehensive hubs, allowing various services and tools to work together seamlessly, increasing efficiency and productivity. By integrating with external applications, users can extend the digital platform's functionality, automate processes, and streamline workflows across different business functions.

Communications platforms, for example, have evolved beyond simple messaging tools into comprehensive ecosystems that facilitate collaboration, automation, and integration with third-party applications. Project management platforms provide users with the ability to connect with time-tracking apps, file-sharing tools, and collaboration solutions. CRM systems, which manage customer relationships and sales processes, integrate with email marketing, customer support, and analytics apps to create a more cohesive user experience. In essence, these digital platforms have become highly adaptable, supporting an ecosystem of apps that empower users to build tailored solutions that fit their unique needs, resulting in more efficient, interconnected, and scalable operations.

As organizations increasingly rely on apps that extend digital platform functionality—such as bots, message extensions, tabs, and meeting integrations—ensuring the security and privacy of these applications has become a pressing challenge. The rapid expansion of these app ecosystems presents a critical issue: how to systematically evaluate the security risks posed by different applications before they are deployed within an organization's infrastructure.

Conventionally, security management systems are not configured with a comprehensive computing logic and infrastructure to efficiently and effectively automate the security of applications in digital platforms. In traditional systems, security management system features may not be configured to assess the permissions an app requests settings, or external APIs. This makes it difficult to understand how the app integrates with the digital platform, complicating the evaluation of its functionality and associated risks. Instead, the security management systems rely on reactive monitoring of the app's behavior after installation, which is less effective than proactive measures.

In addition, evaluating an app's safety based on vendor reputation, online reviews, or external security reports is also unreliable, as many risks may not be publicly known or discovered until after incidents occur. Moreover, security management systems may monitor the app's behavior to detect malicious activity, but advanced threats may evade detection by blending in with normal operations. Additionally, without standardized evaluation processes, app approval becomes inconsistent and prone to human error, making it harder to enforce uniform security policies across integrations. Security management systems may also not have to capacity to identify hidden data sharing or unauthorized external communications, leading to both false positives and false negatives in risk assessments, where benign apps are flagged as malicious, or malicious ones go unnoticed. As such, a more comprehensive security management system—with an alternative basis for performing secure management operations—can improve computing operations and interfaces in security management systems.

At a high level, a manifest-based app risk evaluation engine is a designed to automate the evaluation of applications “apps” (e.g., third-party applications) within digitals platforms by analyzing their manifest files. A manifest or manifest file refers to a file that defines the configurations and functions of an application within a digital platform. The manifest-based app risk evaluation engine provides a structured, repeatable method for assessing security risks by extracting key attributes from an app's manifest, applying a scoring algorithm, and categorizing applications into risk tiers. By leveraging a manifest-driven approach, the manifest-based app risk evaluation engine enables organizations to proactively identify potential security threats, ensure compliance with internal policies, and streamline the approval process for app installations.

Operationally, the manifest-based app risk evaluation engine supports determining the risk of applications associated with digital platforms based on manifest files “manifest”). A manifest can be a structured file (e.g., JSON file) that defines the configurations and functions of an application within a digital platform. The manifest-based app risk evaluation engine supports manifest processing that refers to the process of access, reading, and validating a manifest file to ensure it is correctly structured before security analysis. The manifest-based app risk evaluation engine reads and evaluates manifest files by analyzing their permissions, integrations, data access, authentication mechanisms, and risk indicators. The manifest-based app risk evaluation engine processes each manifest, assigns a risk score (e.g., between 0 and 100) and classifies applications in to risk tiers (e.g., Low, Medium, or High Risk) based on their security posture.

The manifest-based app risk evaluation engine begins by reading and parsing manifest files (e.g., from a specified folder). It ensures that a manifest is properly structured by attempting to parse it using data deserialization. Data deserialization can be done with strict mode disabled to handle escape characters. If a manifest is malformed or cannot be parsed, the manifest-based app risk evaluation engine can immediately assign it a disqualifying risk score and a corresponding notification. For example, a High Risk score of 100 and notification are returned with an example finding that states: “Manifest is invalid JSON. Automatically High Risk.” This prevents further processing of potentially corrupt or incomplete files

If the manifest is valid, manifest-based app risk evaluation engine evaluates the manifest using several security-focused analysis functions (i.e., manifest-based app risk evaluation rules). A manifest-based app risk evaluation rule refers to a security policy that supports evaluating app's risk level based on its manifest, defining how risk is assessed across different manifest-based security factors. A manifest-based app risk evaluate rule can correspond to a security-focused analysis function that is executed to assess the manifest based on a particular manifest-based security factor. A manifest-based security factor is a specific attribute or characteristic within an application's manifest that contributes to its overall risk score by indicating potential security vulnerabilities. These factors include permissions requested, integration points, data access requirements, authentication methods, and external communication dependencies, each of which is assigned a risk sub-score based on its impact on security.

The permissions and scope analysis examines the permissions requested by the app, including built-in permissions like “identity” and “messageMembers”, as well as resource-specific permissions (RSCs). Applications that request high-risk permissions, such as those related to meetings or channels, receive additional penalty scores, especially if the permission type is application-level rather than delegated. The function also considers whether the app defines bot scopes, such as “team”, “meeting”, or “personal”, and assigns risk points accordingly. If the app is not blocked by default until an admin approves it, this is considered an additional security risk.

The integration analysis evaluates how many different digital platform features the app utilizes, including bots, connectors, message extensions, static tabs, and configurable tabs. Each integration type contributes a set amount of risk points, with more integrations leading to a higher potential risk score. The function also considers AI Agents, which allow AI-based processing of chat data, and validDomains, penalizing apps that specify more than three external domains or use wildcard domains like “*.example.com”. The more wildcard domains an app defines, the higher the risk score assigned.

The data access analysis assesses whether the app requests device-level permissions, such as access to geolocation, media, notifications, or external web content. A permission type has an assigned risk weight, with geolocation and media access considered more sensitive than basic permissions like notifications. If the app includes a “webApplicationInfo” field, it suggests Single Sign-On (SSO) integration using an AD App ID. While SSO is generally positive, the function assigns risk if the app also includes an external “resource”, which may indicate data-sharing beyond internal enterprise boundaries. If the manifest includes “graphConnector”, this indicates that the app can interact with a graph, triggering additional risk scoring.

The authentication analysis checks how the app manages user and system authentication. If the app does not include any recognized authentication method, it is flagged as high risk with a default penalty score (e.g., 30 points). If the manifest combines application and delegated permissions, meaning it can act both independently of a user and on behalf of a user, this is considered a security risk due to potential privilege escalation. However, if the app includes both an ID and a resource under webApplicationInfo, this suggests a well-defined SSO implementation, which slightly reduces risk.

The risk indicators analysis identifies additional security concerns, such as whether the app defines multiple meeting scenes, which may indicate complex user data handling. It also checks if the app requests excessive built-in permissions or defines a large number of validDomains. Apps that match these criteria are flagged with findings such as “Multiple meeting scenes (more complex data usage).”

Once all analysis functions have assigned individual sub-scores, manifest-based risk evaluation engine calculates the final risk score using a weighted formula. The factors can be weighted differently and optionally weighted in different percentages and tiers. The factors can be weighted differently based on their direct impact on the overall risk. Permissions, data access, authentication, and integrations are more critical because they directly influence the security and functionality. General risk indicators offer additional context but typically have a smaller influence on the immediate risk evaluation. In one example embodiment, the most influential factors—permissions (30%), data access (25%), authentication (20%), and integrations (20%)—contribute more heavily, while general risk indicators (5%) provide additional refinements. The final score is capped at 100, ensuring no app exceeds the maximum risk threshold. Apps scoring 50 or higher are classified as High Risk, those between 25 and 49 as Medium Risk, and those below 25 as Low Risk.

Manifest-based risk evaluation engine generates a summary of its findings for a corresponding manifest, displaying information associated with the manifest and the risk evaluation (e.g., the file name, app name (if available), final risk score, and risk classification). Manifest-based risk evaluation engine may also aggregate all scores and generate a histogram visualization, illustrating the distribution of risk levels across the analyzed applications. If no valid manifest files are found, the manifest-based risk evaluation engine outputs a message stating: “No manifest files found in the folder or no scores generated.”

To demonstrate how it assigns high-risk classifications, the manifest-based risk evaluation engine includes an example manifest that showcases an app requesting administrator-level permissions, access to multiple digital platform (e.g., communication platform) features, unrestricted external domain communication, and broad data access. This serves as a benchmark for identifying potentially malicious or overly permissive apps. By combining structured JSON parsing, modular security analysis, weighted risk scoring, and visual reporting, manifest-based app risk evaluation engine provides an automated and scalable method for evaluating third-party applications in digital platforms. It helps organizations enforce security policies without requiring manual, time-consuming reviews while ensuring consistency in risk assessment.

By way of example, an enterprise IT security team is tasked with evaluating third-party applications for a communication platform to ensure that only safe and compliant apps are approved for use. The security team uses the manifest-based app risk evaluation engine to automate this process by analyzing the JSON manifest files associated with each app request.

A new app (e.g., TaskMaster) is submitted for review. The app's manifest is loaded into manifest-based app risk evaluation engine, which first attempts to parse the JSON file. The manifest-based app risk evaluation engine successfully reads the manifest, confirming that it is well-formed and contains the required fields. Manifest-based app risk evaluation engine then proceeds to analyze the manifest-based security factors including permissions, integrations, data access, authentication methods, and risk indicators associated with the app.

During permissions analysis, manifest-based app risk evaluation engine detects that the app requests access to “identity” and “messageMembers”, which allows the app to retrieve user identities and send messages on behalf of users. This results in an initial score increase. Further examination reveals that the app also defines resource-specific permissions (RSCs), including “ChannelSettings.ReadWrite.Group”, which allows it to modify channel settings. Since this is an application-level permission, meaning it acts independently of users, manifest-based app risk evaluation engine assigns additional risk points.

In the integration analysis, manifest-based app risk evaluation engine notes that the app includes multiple integration points—it defines a bot, a configurable tab, and a message extension. Each integration type contributes to the overall risk score, with the bot being particularly concerning because it operates in meeting and team contexts, increasing its potential impact.

For data access, the manifest specifies permissions for geolocation, media, and notifications. The manifest-based app risk evaluation engine applies individual scores based on the predefined risk levels for each permission type, adding higher penalties for geolocation and media access, as they involve sensitive user data.

When analyzing authentication, the manifest-based app risk evaluation engine finds that the app does not include “webApplicationInfo”, meaning it lacks a defined SSO mechanism. Additionally, it mixes application and delegated permissions, which could allow privilege escalation. These findings contribute significantly to the final risk score.

Finally, the manifest-based app risk evaluation engine examines risk indicators and discovers that the app lists six validDomains, including *.taskmasterapp.com. The wildcard domain triggers an additional warning because it suggests that the app may communicate with an uncontrolled number of external subdomains, increasing the potential for data exfiltration.

After aggregating the individual scores using the weighted formula, manifest-based app risk evaluation engine assigns the app a final risk score of 62, classifying it as High Risk. The manifest-based app risk evaluation engine generates a report detailing each contributing factor, stating:
“App requests broad team management permissions.”
“Uses Application-level permissions for modifying channels.”
“Includes bot with meeting and team access scopes.”
“Requires geolocation and media access, increasing privacy concerns.”
“Lacks a defined SSO authentication method.”
“Uses wildcard domains, increasing external data exposure risk.”

Because app is classified as High Risk, the security team is alerted and instructed to conduct a manual review before approval. Meanwhile, manifest-based app risk evaluation engine adds the app's score to a histogram visualization, helping the security team track security trends across all evaluated apps. Through this automated process, the manifest-based app risk evaluation engine efficiently identifies security risks, preventing potentially unsafe applications from being deployed without further scrutiny.

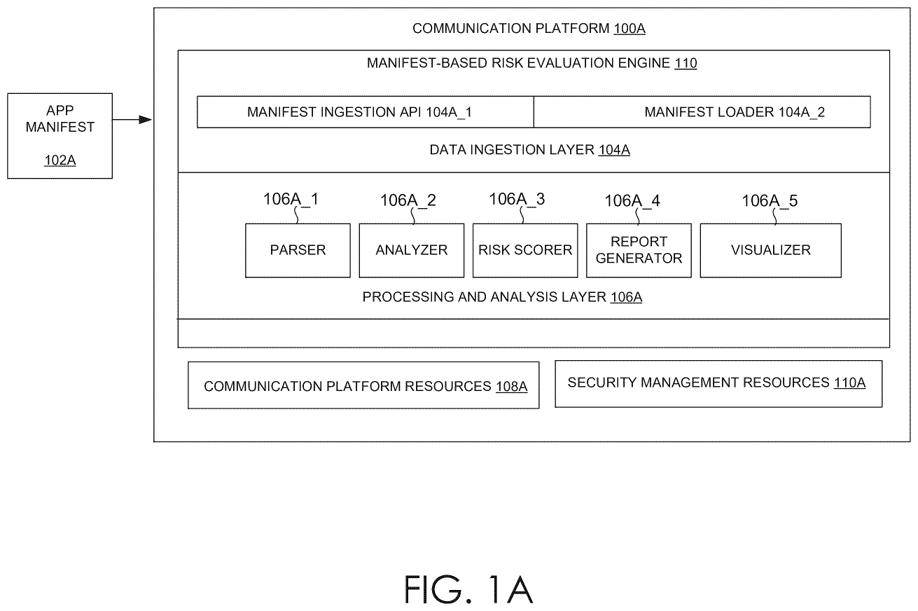

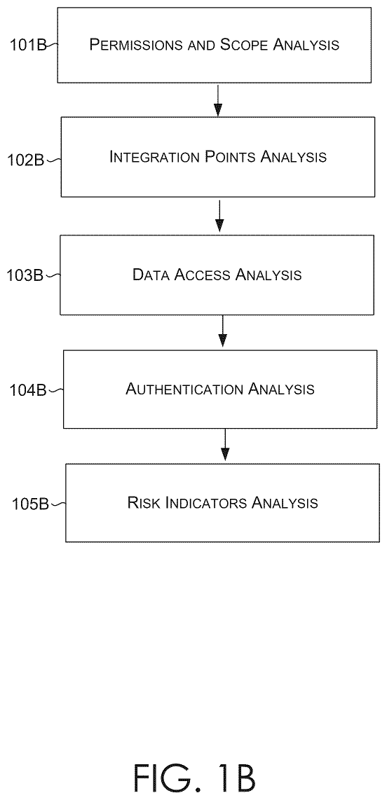

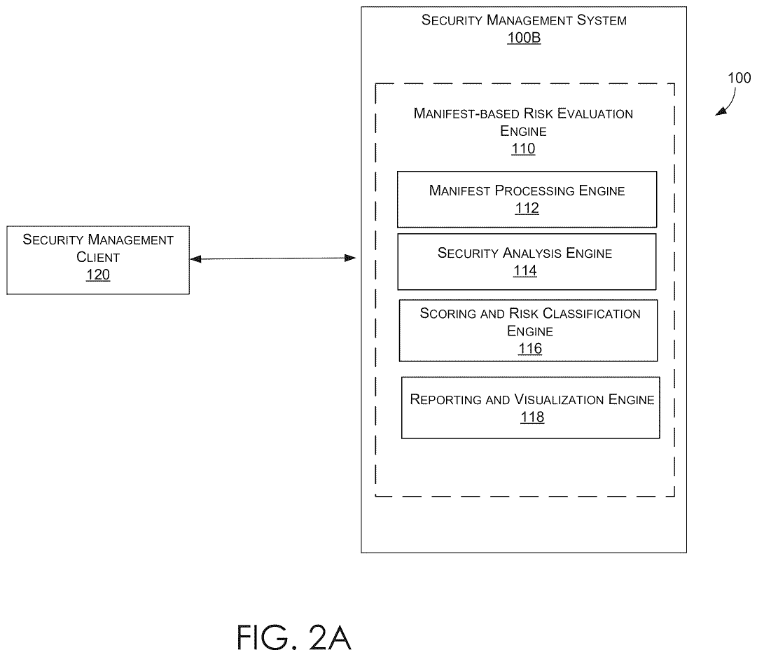

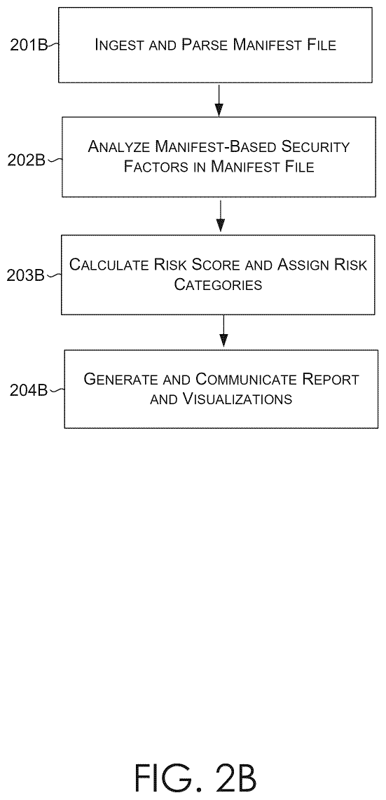

Aspects of the technical solution can be described by way of examples and with reference to FIGS. 1A, 1B, 2A and 2B. FIG. 1A illustrates a digital platform architecture for a communication platform 100A that includes app manifest 102A, manifest-based app risk evaluation engine 110, data ingestion layer 104A with manifest ingestion API 104A_1 and manifest scanner 104A_2; processing and analysis layer 106A with parser 106A_1, analyzer 106A_2, risk score 106A_3, report generator 106A_4, and visualizer 106A_5; communication platform resources 108A, and security management resources 110A.

Manifest-based app risk evaluation engine 110 operates within communication platform 100A to assess the security risks of app (e.g., third-party applications) using their manifest files. Manifest-based app risk evaluation engine 110 provides multiple components that facilitate data ingestion, analysis, scoring, and reporting, ensuring an automated and structured evaluation process.

The communication platform 100A serves as the operating environment where native and third-party applications are integrated and deployed. Communication platform provides the infrastructure required for application management and security enforcement. Manifest-based app risk evaluation engine 110 operates within the communication platform 100A to process and analyze app manifests before deployment. App manifest 102A is the structured document (e.g., JSON document) that defines the app features including permissions, integrations, authentication methods, and external dependencies of an app. App manifest 102A serves as the primary input for the manifest-based app risk evaluation engine 110 which evaluates its security posture and assigns a risk score.

Manifest-based app risk evaluation engine 110 is the core security evaluation system responsible for analyzing the app manifest 102. manifest-based app risk evaluation engine 110 provides multiple layers and functional components that work together to ensure the app meets security and compliance requirements before being approved for use. Data ingestion layer 104A is responsible for retrieving, scanning, and processing app manifest files before analysis. Data ingestion layer 104A includes manifest ingestion API 104A_1 that API handles the retrieval and submission of manifest files from various sources within the communication platform, ensuring structured data intake for further processing. Manifest loader 104A_2 reads in the app manifest 102A and communicates the app manifest 102A for deeper analysis.

Processing and analysis layer 106A is the primary component where security risk assessment occurs. Processing and analysis layer 106A provides functionality associated with a plurality of components. Parser 106A_1 extracts and validates JSON data from the app manifest, ensuring it adheres to the expected schema. If the file is malformed or missing key attributes, the parser flags it as high risk and prevents further processing. Manifest validation is the process of checking whether a manifest is valid or invalid, where an invalid manifest (due to syntax errors, missing fields, incorrect formatting, etc.) is automatically assigned a High Risk score.

Analyzer 106A_2 examines manifest-based security factors. Manifest-based security factors are specific attributes within a manifest, such as permissions, integrations, authentication, data access, and external dependencies, that contribute to the overall risk score. This step identifies potential vulnerabilities and assigns preliminary risk indicators.

Risk Scorer 106A_3 support the process of computing a numerical risk score (0-100) based on weighted security factors, determining the overall risk associated with an application. Risk Scorer 106A_3 computes a final risk score (0-100) by applying a weighted formula that considers security-critical factors. Apps requesting excessive permissions, using weak authentication, or integrating with untrusted external domains receive higher risk scores.

Report Generator 106A_4 produces detailed security reports, summarizing the findings from the analysis. Risk report refers to a document containing findings, which are security observations and risk assessments derived from analyzing an application's manifest, summarizing potential security threats. These reports highlight the security risks associated with the application, providing security teams with actionable insights. Visualizer 106A_5 aggregates risk scores across multiple app manifests and generates graphical representations, such as histograms or dashboards, to illustrate risk distribution and trends within the communication platform. The graphical representation of risk distribution across multiple applications enables tracking trends and assessing security risks over time.

Communication platform resources 108A include native APIs, security policies, and platform-specific tools that help enforce security controls and manage applications within the platform. Manifest-based app risk evaluation engine 110 interfaces with these resources to retrieve relevant data and apply platform-wide security policies. Security management resources 110A include compliance frameworks, security enforcement tools, and threat intelligence services that assist in assessing and mitigating risks identified by the manifest-based app risk evaluation engine 110. Security management resources 110A help security teams take necessary actions, such as blocking high-risk apps or enforcing additional security reviews.

In this way, manifest-based app risk analysis engine employs a structured approach based on general security rules that govern its risk assessment process. These rules—principle of least privilege, minimizing integration footprint, restricting sensitive data access, enforcing strong authentication, and limiting external exposure—form the foundation for evaluating an application's security posture. By applying these principles, manifest-based app risk analysis engine systematically assesses security factors ensuring that applications adhere to best security practices before deployment.

With reference to FIG. 1B, FIG. 1B illustrates a security factors analysis framework that includes modular functions for applying specific security rules that contribute to the overall risk score. Below is a step-by-step breakdown of the analysis process, with the security rules at each step.

At step 101B: Permissions and Scope Analysis—The general application rule here is the principle of least privilege. Applications should request only the minimum permissions necessary for their intended functionality. Built-in permissions, resource-specific permissions, and bot scopes should be limited to avoid excessive access to user data, messages, and administrative controls.

At step 102B: Integration Points Analysis—The general application rule here is minimization of integration footprint. The broader an app integrates across multiple digital platform features (e.g., bots, message extensions, connectors, tabs), the greater its security exposure. Apps with multiple integration points should be carefully reviewed, particularly those spanning high-impact areas like meetings and team-wide contexts.

At step 103B: Data Access Analysis—The general application rule here is restrict sensitive data access. Apps that request access to device-level permissions (e.g., geolocation, media, notifications) or external services (e.g., Graph API) should be scrutinized for necessity. Data access should be explicitly justified, and apps requiring sensitive data should undergo deeper security evaluation.

At step 104B: Authentication Analysis—The general application rule here ins enforce strong authentication. Every application should have a well-defined authentication mechanism. Missing or mixed authentication methods (Application and Delegated permissions) increase security risks by enabling unauthorized or excessive access. Single Sign-On (SSO) via Active Directory is preferred for enterprise security.

At step 105B: Risk Indicators Analysis—The general application rule here is limit external exposure. Apps should minimize communication with external domains and avoid wildcard domains that could allow unrestricted access to unknown third-party services. Excessive use of external integrations or broad validDomains lists should be flagged as a potential data leakage risk.

By way of illustration, the first step in the security evaluation process is the permission and scope analysis (i.e., step 101B) which examines the level of access requested by an application. Built-in permissions such as “identity” and “messageMembers” are considered sensitive, as they provide access to user identities and messaging capabilities. Applications that require these permissions are assigned higher risk scores. Additionally, application-level permissions are scrutinized more heavily than delegated permissions, since application-level permissions allow the app to operate independently of a user, increasing the potential for privilege escalation. The manifest-based app risk evaluation engine also evaluates resource-specific permissions (RSCs), such as “MeetingParticipant.ReadWrite” or “ChannelSettings.ReadWrite”, which allow an app to modify meetings or channels—functionalities that can have a significant security impact. The presence of bots is another consideration, with bots operating in team-wide or meeting contexts receiving higher penalties compared to bots restricted to personal chats. Lastly, if “defaultBlockUntilAdminAction” is set to False, meaning the app does not require administrator approval before use, the risk score is further increased. The system extracts all relevant permissions, applies risk multipliers based on sensitivity, iterates through the list of bots to analyze their scopes, and checks whether admin approval is enforced.

After permissions are evaluated, the integration points analysis (i.e., step 102B) assesses the breadth of the app's interactions within a digital platform. Apps that integrate across multiple platform features inherently pose a greater risk, as each integration point introduces a potential security exposure. The manifest-based app risk evaluation engine counts the number of bots, connectors, message extensions, static tabs, and configurable tabs, applying incremental risk scores based on the number and type of integrations. Applications that utilize AI Agents, which enable AI-driven processing of chat data, receive additional penalties due to privacy concerns associated with automated data handling. The manifest-based app risk evaluation engine then reviews the “validDomains” field, which defines external domains the app interacts with. If an app specifies more than three domains, this suggests a broad external dependency, increasing the likelihood of data exfiltration or unverified third-party communications. The use of wildcard domains (e.g., “*.example.com”) is flagged as particularly high-risk, as it allows unrestricted external communication. The system systematically retrieves and analyzes these integrations, applying weighted penalties based on the number of integrations and the presence of risky configurations.

The next step is the data access analysis (i.e. step 103B), which examines the app's requested access to device-level permissions and external services. Permissions such as “geolocation”, “media”, and “notifications” are evaluated based on their potential to expose sensitive user data. Applications that request geolocation or media access are assigned higher penalties compared to those that require only notifications or external web access. The presence of “webApplicationInfo” is examined to determine if the app integrates with Single Sign-On (SSO) via Active Directory. Proper SSO implementation reduces risk by enforcing authentication through enterprise controls; however, if the app includes an external “resource” within “webApplicationInfo”, this suggests that the app may communicate with external identity providers or third-party services, increasing the risk score. Finally, if “graphConnector” is found in the manifest, indicating the app can interact with Graph API, further penalties are applied due to the potential for reading and writing enterprise-wide data. The system processes each of these attributes, mapping permissions to predefined risk weights and checking for risky external dependencies.

Authentication analysis (i.e., step 104B) ensures that applications enforce appropriate authentication mechanisms. The manifest-based app risk evaluation engine first verifies whether “webApplicationInfo” or “authorization.permissions” are defined in the manifest. If both are missing, the app is immediately flagged as high risk with a default penalty (e.g., 30 points) due to the lack of a structured authentication method. The system then inspects “resourceSpecific” permissions to determine if the app combines application and delegated permissions, which could allow an app to act independently while also impersonating a user—an indicator of potential privilege escalation risks. If an app properly defines both an ID and a resource within “webApplicationInfo”, this suggests a well-configured SSO authentication model, leading to a slight risk reduction. The evaluation process involves retrieving authentication-related attributes, checking for missing or mixed authentication implementations, and applying appropriate scoring adjustments.

The final stage of the security assessment is the risk indicators analysis (i.e., step 105B) which detects additional risk-enhancing patterns in the manifest. Applications that define multiple “meetingExtensionDefinition.scenes” indicate complex meeting integrations, which may involve persistent data access or real-time modifications, increasing security concerns. The presence of AI Agents further raises privacy concerns, as these agents may process chat data for automated responses, potentially exposing sensitive conversations. If an app requests more than three built-in permissions, it is flagged for requesting excessive access. Additionally, the “validDomains” field is reassessed—if the app lists five or more external domains, it suggests a broad external communication footprint, increasing the risk of unauthorized data exchange. The system scans for these indicators, applying risk multipliers where necessary to reflect the increased exposure.

By following this structured evaluation process, manifest-based app risk evaluation engine ensures that all critical security aspects of an app are analyzed comprehensively. Each security factor contributes to the final risk score, which is calculated using a weighted formula to reflect the relative impact of permissions, integrations, data access, authentication, and additional risk indicators. This approach provides a scalable, automated, and repeatable method for assessing third-party applications, ensuring that only safe and compliant apps are approved for deployment.

With reference to FIG. 2A, FIG. 2A illustrates a cloud computing environment (system) 100, security management system 100B, security management client 120; manifest-based app risk evaluation engine 110, manifest processing engine, security analysis engine 114, scoring and risk classification 116, and reporting and visualization engine 118; and security management client 120.

The cloud computing system 100 provides a security management system 110B that is associated with a security management client 100C and manifest-based app risk evaluation engine 110 for providing manifest-based app risk evaluation functionality. The security management system 100B is a centralized platform responsible for managing, monitoring, and enforcing security protocols across an organization's network or system. It integrates with various security services to provide functions such as monitoring, incident response, risk management, and policy enforcement. Security management system 100B collects, analyzes, and takes action on security data, ensuring a proactive approach to handling security events, such as intrusion alerts and breaches.

Security management client 120 operates as the central interface between an organization's security policies and the automated risk assessment performed by the manifest-based app risk evaluation engine 110. Security management client 120 is responsible for requesting, reviewing, and acting upon risk reports generated from the analysis of application manifests. When a new application is submitted for approval, the security management client 120 initiates the evaluation process by requesting a security assessment, triggering manifest-based app risk evaluation engine 110 to analyze the manifest against a predefined set of security rules.

Once manifest-based app risk evaluation engine 110 completes its evaluation, the security management client 120 receives a risk report containing structured findings that highlight vulnerabilities and assign a risk score to the application. This report serves as the basis for decision-making, where the client determines whether the application can be automatically approved, requires further review, or must undergo manual security intervention before deployment. The security management client 120 also monitors risk trends by reviewing risk visualizations generated by manifest-based app risk evaluation engine 110, which provide insights into the security posture of multiple applications over time.

In addition to handling individual application reviews, the security management client 120 manages batch processing, enabling the simultaneous assessment of multiple applications. By leveraging manifest-based app risk evaluation engine 110 automated capabilities, the security management client 120 streamlines the security evaluation process, reducing manual workload while ensuring comprehensive risk assessments. If an application is flagged as high risk, the security management client 120 can support escalating it for further analysis, request modifications from the application provider, or enforce policy-driven restrictions.

The manifest-based app risk evaluation engine 110 is composed of multiple components that work together to analyze and assess the security risk of app manifests. Each component plays a role in processing, evaluating, scoring, and reporting security risks based on structured security rules.

Manifest processing engine 112 supports the first stage of the evaluation process. Manifest processing engine 112 is responsible for scanning a specified directory, reading JSON manifest files, and ensuring their validity before further analysis. Manifest processing engine 112 retrieves manifest files, parses them using json.loads( ) with relaxed settings to handle escape characters, and detects improperly formatted JSON structures. If a manifest fails to parse correctly, it is immediately flagged as High Risk, preventing further processing of potentially corrupted or tampered files. The output of manifest processing engine 112 is either a successfully parsed dictionary representing the manifest or an automatic High Risk classification if the file is invalid.

Once a manifest is validated, the security analysis engine 114 performs a comprehensive evaluation of its security implications. Security analysis engine 114 component examines five key security aspects to identify potential risks. Security analysis engine 114 begins with permissions and scope analysis checking which permissions the app requests—such as identity access, message control, and resource-specific permissions—and assigning a risk score based on their sensitivity. Integration analysis follows, assessing how the app interacts through bots, message extensions, connectors, and tabs, with a broader integration footprint leading to a higher risk classification.

Security analysis engine 114 then conducts a data access analysis, reviewing whether the app requests geolocation, media access, notifications, or external web interactions, as such permissions increase the likelihood of data exposure. Next, authentication verifies whether the app enforces secure authentication mechanisms and flags instances where application and delegated permissions are mixed, as these configurations can lead to privilege escalation risks.

Finally, risk indicators analysis detects high-risk attributes such as wildcard domains, multiple meeting scene integrations, and excessive external API calls. The outputs of this component include security sub-scores (0-100) for each factor and a list of findings, summarizing security concerns detected during the analysis.

With security factors assessed, the scoring and classification engine 116 aggregates the sub-scores and computes a final risk score for the application. Scoring and classification engine 116 applies weighted calculations, ensuring that more critical security concerns—such as permissions and authentication—contribute more significantly to the overall score. The final risk score is capped at 100 to maintain consistency and is then classified into three risk categories: Low Risk (0-24), Medium Risk (25-49), and High Risk (50-100). The risk classification ensures that applications with minimal security concerns can be approved quickly, while those flagged as high risk are subjected to further security reviews before deployment.

To enhance visibility and facilitate decision-making, the reporting and visualization engine 118 generates structured security reports and visual representations of risk distribution. Reporting and visualization engine 118 generates detailed security findings for each analyzed manifest, providing insights into specific vulnerabilities and the reasoning behind each risk score. Additionally, reporting and visualization engine 118 utilizes creates a histogram visualization of risk scores, helping IT security teams track trends and detect patterns in app security evaluations. By aggregating and visualizing risk levels, reporting and visualization engine 118 allows organizations to monitor security trends and make informed policy decisions.

To support bulk processing and system validation, the manifest-based risk evaluation engine 110 processes multiple manifest files simultaneously and includes a predefined high-risk manifest for testing purposes. The manifest-based risk evaluation engine 110 scans a directory for manifest files and processes them sequentially, calling the manifest processing, security analysis, and scoring engines for each file. Manifest-based risk evaluation engine 110 collects the results, consolidates risk scores and findings, and generates a batch risk report summarizing security assessments across all processed manifests. Additionally, the manifest-based risk evaluation engine includes a hardcoded high-risk manifest, which serves as a benchmark for testing and demonstrating how the system detects and flags applications with significant security vulnerabilities.

Together, these components form a comprehensive, automated, and scalable security evaluation system that ensures apps in a digital platform meet security and compliance standards before approval and deployment. By integrating structured manifest processing, in-depth security analysis, weighted risk scoring, and visualization capabilities, the manifest-based risk evaluation engine provides an efficient method for identifying and mitigating security risks across an organization's app ecosystem.

By way of illustration, the manifest-based risk evaluation engine provides a structured approach to assessing the security risks of applications by analyzing their manifest files. The manifest is a file that defines a blueprint of how an application operates, specifying a plurality of features that include permissions, integrations, authentication methods, and external dependencies. These features represent predefined risk factors that contribute to the security evaluation process.

The manifest-based risk evaluation engine begins by accessing a manifest associated with an application and validating its structure. Manifest validation detects whether a manifest is invalid, meaning it contains syntax errors, missing or misplaced brackets, incorrect data types, improper string formatting, or structural inconsistencies. If a manifest is deemed invalid, it is automatically assigned a high risk score, ensuring that improperly formatted applications do not bypass security checks.

Once validated, the manifest-based risk evaluation engine analyzes the manifest based on a plurality of manifest-based app risk evaluation rules. A manifest-based app risk evaluation rule is a security policy that supports evaluating a risk level of applications based on corresponding manifests. Risk level refers to the categorization of an application/s security posture based on its manifest analysis, which evaluates factors such as permissions, integrations, data access, authentication, and external dependencies. The risk level is associated with a risk score that is a numerical value (0-100) assigned to an application based on an analysis of its manifest. The risk level is determined using a weighted risk score (0-100) and is classified into low, medium, or high risk, where:
Low Risk (0-24)—The application meets security standards and can be automatically approved.
Medium Risk (25-49)—The application has moderate security concerns and requires further review before approval.
High Risk (50-100)—The application poses significant security risks and demands manual security intervention before deployment.

The risk level enables organizations to make informed decisions about whether an application is safe to integrate, requires modifications, or must be blocked due to excessive security vulnerabilities.

The manifest-based app risk evaluation rules enforce security best practices to mitigate potential threats posed by third-party applications.

The plurality of manifest-based app risk evaluation rules includes:

Principle of Least Privilege Rule—Ensures that applications request only the minimum permissions necessary for their intended functionality. Minimize Integration Footprint Rule—Flags applications that integrate across multiple features, as broader integrations increase the attack surface. Restrict Sensitive Data Access Rule—Evaluates whether an application requests access to sensitive device-level permissions, such as geolocation or media. Enforce Strong Authentication Rule—Ensures applications implement proper authentication mechanisms and prevents privilege escalation risks. Limit External Exposure Rule—Identifies applications that communicate with an excessive number of external domains or use wildcard domains, which could introduce data leakage risks.

To enforce these rules, manifest-based app risk evaluation engine applies corresponding security analyses, which examine key security aspects of an application: Permissions & Scope Analysis—Evaluates requested permissions, ensuring that applications do not exceed necessary access levels. Integration Points Analysis—Assesses the number and types of Teams features an application integrates with to determine security exposure. Data Access Analysis—Reviews whether an application requests access to sensitive device-level permissions or external services. Authentication Analysis—Checks whether an application has a well-defined authentication mechanism, preventing unauthorized access. Risk Indicators Analysis—Detects high-risk attributes such as wildcard domains, multiple meeting scene integrations, and broad external access permissions.

Based on these analyses, the manifest-based risk evaluation engine generates a risk score for the manifest by assigning risk sub-scores to the plurality of manifest-based security factors and applying a weighted formula with predefined weights. This calculation ensures that certain risk factors—such as excessive permissions or weak authentication—carry a greater impact on the overall risk assessment.

Following the risk score calculation, the manifest-based risk evaluation engine generates a risk report associated with the application. This risk report comprises findings, which are security observations and risk assessments generated from analyzing the manifest. The report provides detailed insights into detected vulnerabilities, allowing administrators to make informed security decisions.

Once the report is generated, the manifest-based risk evaluation engine classifies the application based on a predefined classification framework. This framework defines operational actions based on the risk score: Applications with low risk scores are automatically approved for deployment. Applications with medium risk scores are flagged for review, requiring further examination before approval. Applications with high risk scores require manual security intervention, preventing immediate deployment until security concerns are addressed.

To enhance visibility into security trends, the manifest-based risk evaluation engine generates a visualization representing risk scores associated with a plurality of manifests and corresponding applications. This visualization supports tracking trends and assessing the distribution of security risk scores across applications, allowing administrators to monitor risk levels over time and refine security policies accordingly.

The manifest-based risk evaluation engine is also designed to handle batch processing, enabling administrators to analyze a plurality of manifests simultaneously. By evaluating multiple applications at once, organizations can streamline security assessments and scale risk governance efficiently.

Finally, manifest-based risk evaluation engine supports client-based risk report requests, where a client can request a security assessment for a specific application. Upon receiving the request, the system generates the corresponding risk report and displays the findings for review, ensuring that all stakeholders have access to the necessary security insights.

Through automated manifest validation, structured risk evaluation, weighted risk scoring, and dynamic risk visualization, manifest-based risk evaluation engine ensures that applications adhere to security best practices before being integrated into a digital platform. The structured approach enforces manifest-based security rules, reduces the burden of manual security reviews, and enables organizations to detect, analyze, and mitigate security risks at scale.

With reference to FIG. 2B, FIG. 2B illustrates a flow diagram associated with providing manifest-based app risk evaluation using a manifest-based app risk evaluation engine in a security management system. A manifest-based app risk evaluation workflow can include the following steps:

At step 201B—Ingest and Parse Manifest File: The process begins with manifest file ingestion and parsing manifest files. For example, the manifest-based app risk evaluation engine scans a designated directory for JSON manifest files. Each manifest file is read and parsed using a JSON parser with relaxed error handling to accommodate escape characters and minor formatting inconsistencies. It is contemplated that if a manifest file is found to be malformed—such as containing syntax errors, missing required fields, or using an invalid structure—the manifest-based app risk evaluation engine immediately assigns it a high risk score of 100, flags it for further review, and generates a warning stating that the manifest is not well-formed. This ensures that only correctly structured manifests proceed to the next stage, preventing potential security risks associated with incomplete or corrupted files.

At step 202B—Analyze Manifest-based Security Factors in Manifest File: Once a manifest is successfully parsed, manifest-based app risk evaluation engine performs a detailed security analysis by evaluating multiple manifest-based security factors that contribute to the overall risk level of an application. The first area of assessment can be permissions and scope, where the manifest-based app risk evaluation engine extracts the “permissions” field to determine the level of access requested by the app. Built-in permissions (e.g., “identity” and “MessageMembers”) are analyzed, and higher risk scores are assigned if the app requests broad access to user data or administrative controls.

For example, the identity permission allows the app to access information about the user who is interacting with it. It typically enables the app to retrieve the user's identity, profile details, and other related information such as the user's membership or organization. This permission can be used to customize interactions or target specific individuals in the organization. MessageMembers permission allows the app to send messages to the members in a specific team or channel. It grants the ability to interact with members via the app, sending messages, notifications, or other types of communication. This can be used for automated interactions, such as alerts, reminders, or updates that the app might need to deliver to the entire team or certain members.

Resource-specific permissions (RSCs) are also examined, with a particular focus on whether the app uses application-level permissions, which operate independently of user actions, or delegated permissions, which require user authentication. Since application-level permissions present greater security risks, they contribute more heavily to the app's overall score. Additionally, manifest-based app risk evaluation engine evaluates bot scopes, identifying whether the app interacts in personal, group chat, team, or meeting contexts, with wider scopes leading to increased risk scores. If the app does not enforce administrative approval before being used—for example (“defaultBlockUntilAdminAction”: false), this is flagged as an additional security concern.

The next area of assessment is integration points, where manifest-based app risk evaluation engine determines how the app interacts with the digital platform. The manifest-based app risk evaluation engine checks whether the app includes bots, message extensions, static or configurable tabs, or connectors, with each integration type contributing to the risk score. Apps that span multiple integration points are considered riskier due to their increased attack surface. If the app includes AI Agents, which can process chat data using AI, additional risk points are assigned.

Furthermore, manifest-based app risk evaluation engine inspects the app's valid domains (e.g., “validDomains” field) which lists external domains the app interacts with. Apps specifying more than three external domains are penalized, with wildcard domains (*.example.com) receiving the highest risk scores, as they allow unrestricted communication with dynamically generated subdomains.

Manifest-based app risk evaluation engine then evaluates data access by examining device permissions (e.g., “devicePermissions”) which indicate whether the app requests access to features such as geolocation, media files, notifications, or external web links. Each permission type is assigned a predefined risk score, with geolocation and media access considered more sensitive than basic permissions like notifications. If “webApplicationInfo” is present, manifest-based app risk evaluation engine checks whether the app uses Single Sign-On (SSO) via an Active Directory App ID. Apps that define both an ID and an external “resource” are flagged as higher risk due to their potential for data sharing beyond internal enterprise boundaries. If the manifest includes graph connectors (e.g., “graphConnector”), which allows the app to read and write data through a graph API, an additional risk penalty is applied.

The next area of assessment is authentication, that includes examining how the app manages user and system authentication. The manifest-based app risk evaluation engine checks for the presence of SSO authentication using an app manifest property that defines the configuration for integrating external web applications. The property specifies details such as the URLs for accessing the web application and authentication requirements, enabling secure interaction between the web app and the digital platform. For example, the manifest-based app risk evaluation engine identifies whether the app has a “webApplicationInfo” section defines an Active Directory App ID. If no authentication method is found, the app is flagged as high risk with a default penalty score.

The manifest-based app risk evaluation engine also identifies whether the app mixes Application and Delegated permissions, which could enable privilege escalation by allowing the app to operate both independently and on behalf of a user. If an app includes both an ID and a resource in its SSO configuration, manifest-based app risk evaluation engine recognizes this as a positive security practice and slightly reduces the app's overall risk score.

Following authentication analysis, manifest-based app risk evaluation engine inspects additional risk indicators, which include additional security concerns beyond the core evaluation criteria. Apps that define multiple meeting scenes are flagged due to their potential for complex data handling and expanded interaction surfaces. The manifest-based app risk evaluation engine also checks whether the app requests an excessive number of built-in permissions or defines an unusually large number of validDomains, both of which increase the likelihood of external dependencies or unauthorized data exposure. If any of these risk indicators are present, manifest-based app risk evaluation engine generates findings such as “Multiple meeting scenes detected, increasing complexity of data handling.”

At step 203B—Calculate Risk Score and Assign Risk Categories: Once all risk indicators have been analyzed, manifest-based app risk evaluation engine calculates the final risk score using a weighted formula. Different security aspects contribute to the final score in proportion to their impact—for example, permissions and scope (30%), data access (25%), authentication (20%), and integration points (20%) accounting for the majority of the score, while risk indicators (5%) serve as a refinement mechanism. The final score is capped at 100, ensuring that no app exceeds the maximum risk threshold. The manifest-based app risk evaluation then assigns the app to a risk category based on the following example thresholds:
Low Risk (0-24)—The app is considered safe and may be approved without further review.
Medium Risk (25-49)—The app requires additional verification from the IT security team before deployment.
High Risk (50-100)—The app is flagged for immediate manual review before any approval is considered.

At step 204B—Generate and Communicate Report and Visualizations: To provide transparency and facilitate decision-making, the manifest-based app risk evaluation engine generates a structured report for each manifest, detailing the key findings and explaining why the app received its specific score. The manifest-based app risk evaluation engine can communicate a the report and/or a summary of results that include file name, app name (if available), final risk score, and risk classification. In addition, manifest-based app risk evaluation engine all risk scores and visualizes the distribution of risk levels using a histogram, helping IT teams track security trends and detect patterns in app requests over time.

To validate its risk scoring methodology, manifest-based app risk evaluation engine includes a sample high-risk manifest that demonstrates potential vulnerabilities. This example showcases an app that requests administrator-level permissions, multiple integrations, unrestricted external domain communication, and broad data access, serving as a benchmark for understanding how high-risk configurations are flagged. By using a real-world example, manifest-based app risk evaluation engine helps security teams recognize common security pitfalls when reviewing third-party applications.

The manifest-based app risk evaluation engine is designed to support batch processing, allowing organizations to evaluate multiple manifests simultaneously. It can also be integrated into existing IT security workflows enabling seamless approval pipelines. Additionally, manifest-based app risk evaluation engine maintains an audit log of risk scores and findings for compliance tracking, ensuring that organizations have a historical record of app security assessments.

Through this structured process, manifest-based app risk evaluation engine provides an automated, repeatable, and scalable solution for assessing the security risks of third-party applications in a digital platform. By eliminating the need for manual reviews, the system enhances security while maintaining efficiency, ensuring that only safe and compliant applications are approved for use within an organization.

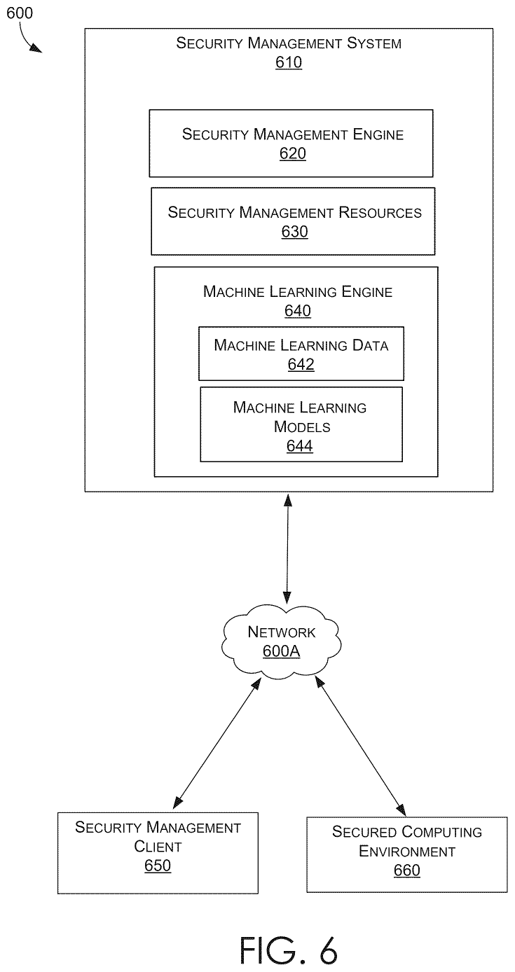

Aspects of the technical solution have been described by way of examples and with reference to FIGS. 1A, 1B, 2A and 2B. FIG. A1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

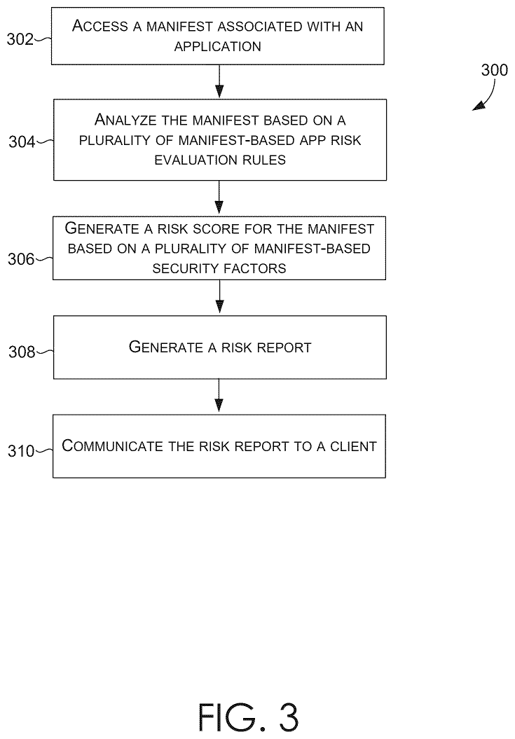

With reference to FIGS. 3, 4, and 5, flow diagrams are provided illustrating methods for providing manifest-based app risk evaluation using a manifest-based app risk evaluation engine of a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system).

Turning to FIG. 3, a flow diagram is provided that illustrates a method 300 for providing manifest-based app risk evaluation using a manifest-based app risk evaluation engine of a security management system. At block 302, access a manifest associated with an application. At block 304, analyze the manifest based on a plurality of manifest-based app risk evaluation rules, wherein a manifest-based app risk evaluation rule is a security policy that supports evaluating a risk level of applications based on corresponding manifests. At block 306, based on analyzing the manifest, generate a risk score for the manifest based on a plurality of manifest-based security factors that correspond to the plurality of manifest-based app risk evaluation rules. At block 308, based on generating the risk score, generate a risk report associated with the application. At block 310, communicate the risk report to a client.

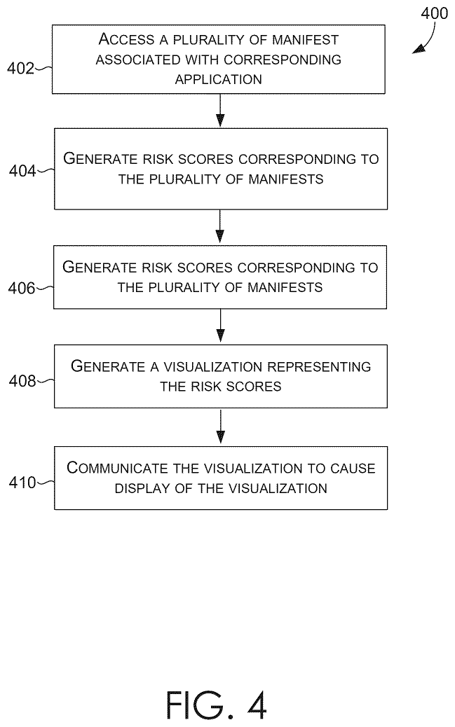

Turning to FIG. 4, a flow diagram is provided that illustrates a method 400 for providing manifest-based app risk evaluation using a manifest-based app risk evaluation engine of a security management system. At block 402, access a plurality of manifests associated with corresponding applications. At block 404, analyze the plurality of manifests based on a plurality of manifest-based app risk evaluation rules, wherein a manifest-based app risk evaluation rule is a security policy that supports evaluating a risk level of applications based on corresponding manifests. At block 406, based on analyzing the manifest, generate risk scores corresponding to the plurality of manifests, wherein generating the risk scores is based on a plurality of manifest-based security factors that correspond to the plurality of manifest-based app risk evaluation rules. At block 408, based on generating the risk scores, generate a visualization representing the risk scores associated with the plurality of manifests and the corresponding applications, wherein the visualization supports tracking security risk scores across the plurality of applications. At block 410, communicate the visualization to cause display of the visualization.

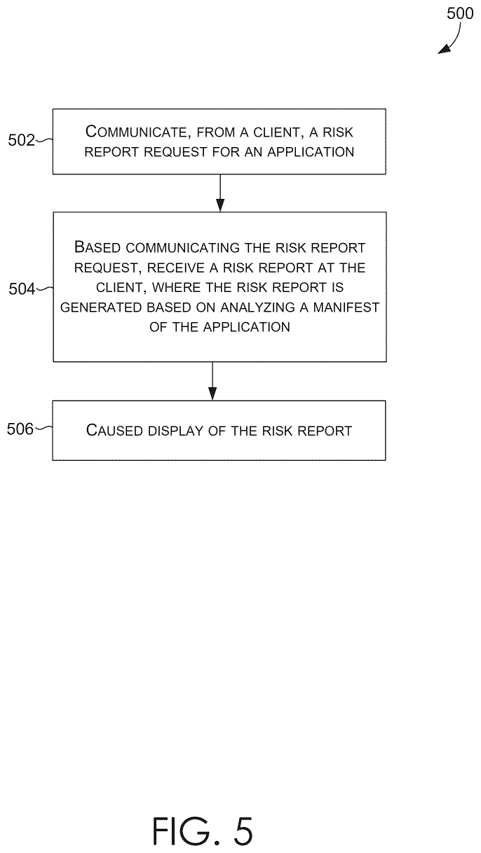

Turning to FIG. 5, a flow diagram is provided that illustrates a method 500 for providing manifest-based app risk evaluation using a manifest-based app risk evaluation engine of a security management system. At block 502, communicate, from a client, a risk report request for an application. At block 504, based on communicating the risk report request, receive a risk report at the client, wherein the risk report is generated based on analyzing a manifest of the application, wherein analyzing the manifest is based on a plurality of manifest-based app risk evaluation rules, wherein a manifest-based app risk evaluation rule is a security policy that supports evaluating a risk level of applications based on corresponding manifests. At block 506, cause display of the risk report.

Embodiments of the present techniques have been described with reference to several inventive features (e.g., operations, systems, engines, and components) associated with a security management system. Inventive features described include operations, interfaces, data structures, and arrangements of computing resources associated with providing the functionality described herein relative with reference to a manifest-based app risk evaluation engine. Functionality of the embodiments of the present invention have further been described, by way of an implementation and anecdotal examples—to demonstrate that the operations for providing the manifest-based app risk evaluation engine as a solution to a specific problem in security management technology to improve computing operations in security management systems.

By way of illustration, manifest-based app risk evaluation engine enables operations including manifest validation and analysis, risk scoring and classification, and risk reporting with visualization. Manifest-based app risk evaluation engine begins by retrieving and validating an application's manifest, ensuring it is properly structured before analyzing permissions, integrations, data access, authentication, and risk indicators against predefined security rules. The manifest-based app risk evaluation engine then calculates a weighted risk score (0-100), classifies applications as low, medium, or high risk, and determines whether they can be approved, flagged for review, or require manual intervention. Finally, the manifest-based app risk evaluation engine generates a detailed risk report, communicates findings to a security management client and provides visual insights into security trends, enabling organizations to efficiently assess multiple applications at scale and enforce security policies proactively.

Manifest validation and analysis introduce a computer-implemented process that automatically retrieves, parses, and verifies the integrity of an application's manifest, ensuring only valid, well-structured data is processed. This operation prevents errors and enables a standardized security evaluation by applying predefined security rules to permissions, integrations, data access, authentication, and risk indicators. Risk scoring and classification utilize a computational model with a weighted risk calculation, assigning objective, numerical risk scores (0-100) and classifying applications into low, medium, or high risk, reducing the need for subjective manual reviews. This structured, algorithmic approach enhances the efficiency and accuracy of security assessments. Finally, risk reporting with visualization transforms raw security evaluations into structured risk reports and graphical insights, enabling administrators to track security trends and proactively refine policies. The system's ability to automate risk assessment, classify applications programmatically, and generate security intelligence at scale introduces novel, technical advancements that support efficient security management, enterprise compliance, and proactive risk mitigation, making it a scalable and patent-eligible solution.

Referring now to FIG. 6, FIG. 6 illustrates a computing environment in which implementations of the present disclosure may be employed. In particular, FIG. 6 shows a high level architecture of an example cloud computing platform 600 and security management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing system 100 provides computing system resources for different types of managed computing environments. For example, the cloud computing platform supports delivery of computing services—including compute, servers, storage, databases, networking, and intelligence. The components of cloud computing platform 600 may communicate with each other over a network 600A which may include, without limitation, one or more local area networks (LANs) and/or wide area networks (WANs).

The security management system 610 provides security management functionality for computing environments. The security management system 610 supports planning, implementing, controlling, and monitoring security measures to protect assets, resources, and information from various threats and risks in computing environment. Security management system 610 is configured to trigger alerts for potential or actual threats—including suspicious behavior or malicious behavior—in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert.

Different types of potential threats and actual threats exist, for example, use of proxies to gain access to a computing environment or unauthorized running of crypto mining software in a computing environment. An attack on a cloud computing environment—for example, performed by a malicious actor—can include several attack operations that are executed to gain access to resources on the cloud computing environment. The attack operations can trigger alerts, when the security system is configured to monitor for these types of attack operations. If multiple attack operations are identified—and a determination that the attack operations are related is made—the alerts associated with the attack operations can be defined as a security incident. The security incident can refer to a collection of correlated alerts and corresponding security data that make up a story of an attack. The attack story can be associated with a security graph and an attack path definition that identifies attack objects (e.g., attack operations, compromised resources, file locations and file types). The attack path can describe how an attacker gained access to a computing environment and related operations and computing resources associated with the attack and unauthorized access. A security incident can advantageously combine multiple alerts associated with a single attack to support managing and responding to the security incident.

The security management system 610 includes a security management engine 620 that is a computing environment that supports executing computational tasks associated with the security management system 610. The security management engine 620 can be a hardware or software component that performs computational operations, such as, mathematical calculations, data processing, and algorithm execution. The security management system 610 integrates security management resources 630 into security management system 610 to effectively provide security management in a computing environment.

The security management engine 620 can be a security posture management engine that is responsible for communicating with security management client 650. The security management client 650 supports client-side security management operations for providing security management in the security management system 610. The security management client 650 supports presenting a security posture visualization associated with security management engine output and communicating an indication to perform a remediation action associated with security management engine output. The security management engine 620 operates to provide visibility to security status of resources in a computing environment. Security posture information can be associated with security management engine output. Security posture information can include security management engine output as described herein with regard to the technical solution.

The security management engine 620 includes a security graph API that provides access to a security graph security graph data. The security graph provides telemetry data associated with a plurality of resources in a computing environment. In particular, the telemetry data can be security data that is associated with security providers in a computing environment. The security graph and security graph API can support integrating security alerts from different security providers via an API connector that streams alerts to the security management engine 620.

The security management engine 620 may assess threats and develop risk scores—using risk assessment operations. A risk associated with security management engine output can used to generate security posture information. In particular, a risk score can refer to a numerical value that represents the level of risk associated with a particular security incident associated with the annotation. It takes into account various factors such as the likelihood of the event occurring and the potential impact of the event if it does occur. The risk score is used to prioritize actions and allocate resources accordingly.

The security management engine 620 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The security management client 650 can support accessing a security posture visualization and causing display of the security posture visualization. The security management client 650 can include the security posture management engine client that supports receiving security posture information associated security management engine output from the security management system 610 and causing presentation of the security posture information. The security posture information can specifically include security posture visualizations associated with the security management engine output. The secure posture visualization can further include remediation actions associated different alerts—including alerts that are associated with the security management engine output. The security management system can be a security management system described in U.S. patent application Ser. No. 18/451,405, filed Aug. 17, 2023, entitled “ARTIFICIAL INTELLIGENCE ENGINE IN A SECURITY MANAGEMENT SYSTEM.”

The security management client 130 can further support executing a remediation action. In particular, the security posture visualization can include a remediation action for an alert associated with security management engine output. The security management client 130 can receive an indication to perform the remediation action associated with security management engine output. Based on receiving the indication to execute the remediation action, the security management client 130 can communicate the indication to execute the remediation action to cause execution of the remediation action.

The security management resources 630 refer to computing elements (e.g., components, capability, or entities) that collectively enable the security management engine 620 operations. The security management resources 630 encompass a spectrum of computing elements, beginning with the diverse operations the security management resources 630 can perform, ranging from complex computations to data manipulations. Interfaces, an integral part of the security management resources 630, provide the means for both user interaction and seamless integration with external systems, ensuring a dynamic and interactive computing experience. The data facet of the security management resources 630 involves various types: input data, which is the information provided for processing; processing data, representing the data manipulated during computational tasks; and output data, the results generated by the security management engine 620. In this way, the security management resources 630 support the security management engine 620 and security management system 610.

Security management resources 630 manifest-based app risk evaluation engine resources that support leveraging contextual information and impact analysis to thwart or mitigate ongoing attacks on a computing environment. Manifest-based app risk evaluation engine resources encompass the core operations, interfaces, and data components within security management system 610, collectively supporting its functionality in overseeing diverse computing environments across the cloud computing platform 600. Operations of the manifest-based app risk evaluation engine resources include understanding the normal behavior and processes within the computing environment. This includes monitoring system operations, network traffic, user activities, and application behavior to establish a baseline of normalcy. When an attack occurs, security analysts can analyze the deviation from normal operations to identify anomalies or suspicious activities. By understanding the context in which these deviations occur, such as the timing, sequence, and frequency of events, analysts can assess the severity and potential impact of the attack. Interfaces, including graphical user interfaces, command-line interfaces, web-based portals, APIs, and integration points, facilitate interaction with administrators, end-users, devices, and other cloud computing systems. Data components encompass the storage, processing, and transmission of data within the computing environment. This includes databases, file systems, memory, and data pipelines. Contextual attack disruption in the context of data components involves monitoring data flows, access patterns, and data integrity to detect and mitigate attacks targeting sensitive information.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The security management client 650 supports access to security management system 610. Security management client 650 provides a graphical or command-line interface for users or administrators to interact with security management system 610, handling tasks such as planning, implementing, controlling, and monitoring security measures to protect assets, resources, and information from various threats and risks in computing environments. The security management client 650 supports centralized security management, security enforcement, and compliance within a computing environment (e.g., organization's infrastructure), empowering efficient security administration and safeguarding resources.

Secured computing environment 660 can refer to a computing environment that is secured using the security management system 610. For example, cloud computing environments provided by cloud providers encompass various types, including public, private, hybrid, and multi-cloud environments, as well as containerized environments. In a public cloud setup, resources are shared among multiple customers and accessed over the internet, with security managed by the provider through measures like network segmentation and encryption. Private clouds, dedicated to a single organization, offer greater control and are secured through strict access controls and encryption, either by the organization itself or a third-party provider. Hybrid clouds combine elements of public and private clouds, requiring integrated security measures across both environments, such as identity federation and consistent monitoring. Multi-cloud environments leverage services from multiple providers, necessitating standardized security policies and controls for consistent protection. Containerized environments, utilizing technologies like Docker and Kubernetes, secure applications through container image scanning, runtime monitoring, and access control. Across all types, the security management system 610 can provide security management, including compliance certifications, threat intelligence, and security consulting, to safeguard data, infrastructure, and applications from evolving cyber threats and ensure adherence to regulatory requirements.

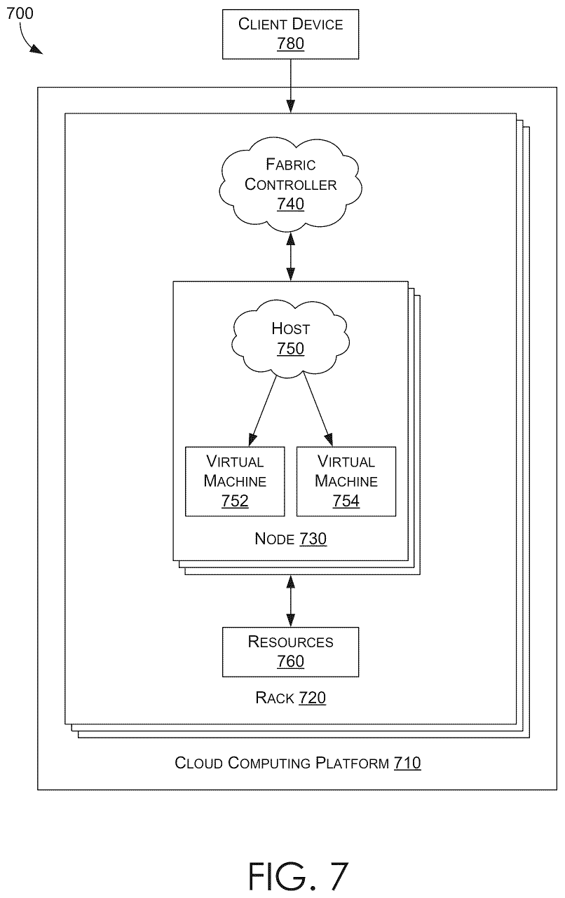

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

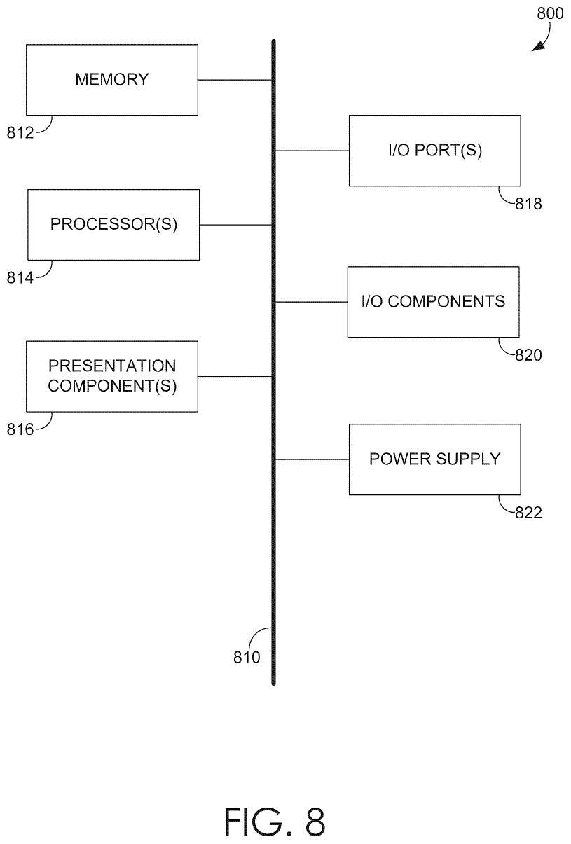

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a manifest associated with an application;
analyzing the manifest based on manifest-based app risk evaluation rules, wherein a manifest-based app risk evaluation rule is a security policy that supports evaluating a risk level of applications based on corresponding manifests;
based on analyzing the manifest, generating a risk score for the manifest based on manifest-based security factors that correspond to the manifest-based app risk evaluation rules;
based on generating the risk score, generating a risk report associated with the application; and
communicating the risk report to a client.

2. The system of claim 1, wherein the manifest is file that identifies a plurality of features that define a blueprint of how the application operates, wherein the plurality of features comprise a plurality of predefined risk factors associated with generating the risk report for the application.

3. The system of claim 1, the operations further validating the manifest, wherein validating the manifest is associated with detecting invalid manifests, wherein an invalid manifest is automatically assigned a high risk score, wherein an invalid manifest is associated with one or more of: syntax error, missing or misplaced bracket, incorrect data types, improper string formatting, or structuring inconsistencies.

4. The system of claim 1, wherein the manifest-based app risk evaluation rules include:
a principle of least privilege rule;
a minimize integration footprint rule;
a restrict sensitive data access rule;
an enforce strong authentication rule; and
a limit external exposure rule.

5. The system of claim 1, wherein the manifest-based app risk evaluation rules are associated with corresponding analysis including:
a permissions and scope analysis;
an integration points analysis;
a data access analysis;
an authentication analysis; and
a risk indicators analysis.

6. The system of claim 1, wherein the manifest-based security factors are associated with corresponding risk sub-scores, wherein generating the risk score is based on a weighted formula is associated with predefined weights for the manifest-based security factors.

7. The system of claim 1, wherein the risk report comprises findings associated with the manifest, wherein the findings are security observations and risk assessments generated from analyzing the manifest of the application.

8. The system of claim 1, the operations further comprising classifying the application based on a predefined classification framework, wherein classifications of the predefined classification framework are associated with operational functionality including: automatically approving applications, flagging applications for review, and flagging applications manual security intervention.

9. The system of claim 1, the operations further comprising generating a visualization representing risk scores associated with manifests and corresponding applications, wherein the visualization supports tracking trends and assessing a distribution of security risk scores across applications.

10. A computer-implemented method, the method comprising:
accessing manifests associated with corresponding applications;
analyzing the manifests based on manifest-based app risk evaluation rules, wherein a manifest-based app risk evaluation rule is a security policy that supports evaluating a risk level of applications based on corresponding manifests;
based on analyzing the manifest, generating risk scores corresponding to the manifests, wherein generating the risk scores is based on manifest-based security factors that correspond to the manifest-based app risk evaluation rules;
based on generating the risk scores, generating a visualization representing the risk scores associated with the manifests and the corresponding applications, wherein the visualization supports tracking security risk scores across the applications; and
communicating the visualization to cause display of the visualization.

11. The computer-implemented method of claim 10, wherein the manifest-based app risk evaluation rules include:
a principle of least privilege rule;
a minimize integration footprint rule;
a restrict sensitive data access rule;
an enforce strong authentication rule; and
a limit external exposure rule.

12. The computer-implemented method of claim 10, wherein manifest-based app risk evaluation rules are associated with corresponding analysis including:
a permissions and scope analysis;
an integration points analysis;
a data access analysis;
an authentication analysis; and
a risk indicators analysis.

13. The computer-implemented method of claim 10, the method further comprising generating risk reports corresponding to the manifests, the risk reports comprising findings that are security observations and risk assessments.

14. One or more computer-storage media having computer-executable instructions embodied thereon that, when executed by a computing system having a processor and memory, cause the processor to perform operations, the operations comprising:
communicating, from a client, a risk report request for an application;
based on communicating the risk report request, receiving a risk report at the client, wherein the risk report is generated based on analyzing a manifest of the application, wherein analyzing the manifest is based on manifest-based app risk evaluation rules, wherein a manifest-based app risk evaluation rule is a security policy that supports evaluating a risk level of applications based on corresponding manifests; and
causing display of the risk report.

15. The media of claim 14, wherein the manifest is file that identifies a plurality of features that define a blueprint of how the application operations, wherein the plurality of features comprise a plurality of predefined risk factors associated with generating the risk report for the application.

16. The media of claim 14, wherein the manifest-based app risk evaluation rules include:
a principle of least privilege rule;
a minimize integration footprint rule;
a restrict sensitive data access rule;
an enforce strong authentication rule; and
a limit external exposure rule.

17. The media of claim 14, wherein the manifest-based app risk evaluation rules is associated with corresponding analysis including:
a permissions and scope analysis;
an integration points analysis;
a data access analysis;
an authentication analysis; and
a risk indicators analysis.

18. The media of claim 14, wherein the risk report comprises findings associated with the manifest, wherein findings are security observations and risk assessments generated from analyzing the manifest of the application.

19. The media of claim 14, wherein the risk report indicates the application is associated with a risk category classification, wherein classifications are associated with operational functionality including: automatically approving applications, flagging applications for review, and flagging applications manual security intervention.

20. The media of claim 14, wherein the risk report is associated with a visualization representing risk scores associated with manifests and corresponding applications, wherein the visualization supports tracking trends and assessing a distribution of security risk scores across the applications.
